(19) United States
(12) Patent Application Publication
(10) Pub. No.: US 2024/0243560 A1
(43) Pub. Date: Jul. 18, 2024

(54) FUNCTION-ADDING ELECTRICAL WIRING AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Daichi ASHIDA, Mie (JP)

(21) Appl. No.: 18/290,296

(22) PCT Filed: Mar. 25, 2022
(86) PCT No.: PCT/JP2022/014383

§ 371 Date: Nov. 12, 2023

(30) Foreign Application Priority Data
May 24, 2021 (JP) 2021-086873

(51) Int. Cl. H02G 3/04; B60R 16/02; H01B 7/00

(52) U.S. Cl. CPC H02G 3/0418; B60R 16/0215; H01B 7/0045

(57) ABSTRACT

Function-adding electrical wiring (10) according to an aspect of the present disclosure includes: one or more electrical wires (11); and an attachment part (12). The electrical wires (11) are not initially used, and are to be electrically connected to an electrical component when a function is to be added. The electrical wires (11) are attached to the attachment part (12), and the attachment part (12) is to be attached and fixed to a protector body (4) in which a main harness (2) is routed.

### TECHNICAL FIELD

The present invention relates to function-adding electrical wiring and a wire harness.

### BACKGROUND

Conventionally, a vehicle is provided with a wire harness for electrically connecting electrical components mounted on the body of the vehicle. When a wire harness is to be routed, the portion of the wire harness that will be subjected to loads such as weight and impact is passed through a protector, and thus the portion is protected from such external loads (see Patent Document 1). A material such as resin is used for this type of protector, and such a protector is placed on the lower surface of the floor in the vehicle.

### PRIOR ART DOCUMENT

### Patent Document

Patent Document 1: JP 2012-222900 A

### SUMMARY OF THE INVENTION

### Problems to be Solved

After a vehicle is shipped to the market, a system or a function may be retrofitted to the vehicle. Depending on the system or function to be added, it may be necessary to add a wire harness and electrically connect electrical components, using the wire harness. In such a case, there is a problem in that work performed to removing the protector and adding a harness requires time and effort. In addition, if the protector is placed on a portion from which the protector cannot be removed, there is a possibility that a harness cannot be added.

An object of the present disclosure is to provide function-adding electrical wiring, which can realize function addition without a drastic design change, and a wire harness.

### Means to Solve the Problem

Function-adding electrical wiring for solving the above-described problem includes: one or more electrical wires that are not initially used, and are to be electrically connected to an electrical component when a function is to be added; and an attachment part to which the electrical wires are attached, and that is to be attached and fixed to a protector body in which a main harness is routed.

A wire harness for solving the above-described problem includes: a main harness; a protector through which the main harness is passed so as to regulate a wiring route for the main harness or partition a route for the main harness; and function-adding electrical wiring configured to be used when a function is to be added. The function-adding electrical wiring includes: one or more electrical wires that are not initially used, and are to be electrically connected to an electrical component when a function is to be added; and an attachment part to which the electrical wires are attached, and that is attached and fixed to a protector body in which the main harness is routed.

### Effect of the Invention

According to the present disclosure, it is possible to realize function addition without a drastic design change.

### BRIEF DESCRIPTION OF THE DRAWINGS

FIG. 1 is a perspective view of a wire harness according to a first embodiment.

FIG. 2 is an exploded perspective view of function-adding electric wiring viewed from a rear surface side.

FIG. 3 is a cross-sectional view taken along a line III-III shown in FIG. 2.

FIG. 4 is a plan view enlarging a leading end of an electrical wire.

FIG. 5 is a schematic diagram showing an example in which a wire harness is attached to a body of a vehicle.

FIG. 6 is a perspective view of function-adding electrical wiring viewed from a rear surface side.

FIGS. 7A and 7B are diagrams showing processing procedures for a binding member fixing rib.

FIG. 8 is an assembly diagram for the wire harness.

FIGS. 9A to 9C are diagrams showing procedures for connecting an additional wire to the function-adding electrical wiring.

FIG. 10 is a perspective view of function-adding electrical wiring according to a second embodiment viewed from a rear surface side.

FIG. 11 is a perspective view of a wire harness.

FIG. 12 is an exploded perspective view of the function-adding electrical wiring according to the second embodiment viewed from the rear surface side.

FIG. 13 is a perspective view of the wire harness.

### DETAILED DESCRIPTION TO EXECUTE THE INVENTION

First, embodiments of the present disclosure will be listed and described.

[1] Function-adding electrical wiring according to the present disclosure includes: one or more electrical wires that are not initially used, and are to be electrically connected to an electrical component when a function is to be added; and an attachment part to which the electrical wires are attached, and that is to be attached and fixed to a protector body in which a main harness is routed.

In the configuration according to the present disclosure, the function-adding electrical wiring has been prepared in the protector as electrical wires to be used when a function is to be added. Therefore, when an electrical component is to be electrically connected when a function is to be added, it is possible to electrically connect the electrical component to be retrofitted by performing a simple operation, using an electrical wire included in the function-adding electrical wiring. Therefore, it is possible to realize function addition without a drastic design change.

[2] The attachment part is provided with a lid member configured to close an opening of the protector body. With this configuration, the attachment part can also be used as the lid member for the protector, which contributes to reducing the number of parts.

[3] The lid member is configured to close the opening of the protector body so that both the main harness and the electrical wires are positioned within the protector body. With this configuration, the electrical wire group constituted by the main harness and the function-adding electrical wires can be housed within the protector, so that the electrical wire group does not have to be left exposed to the outside.

[4] At least one end portion of each of the electrical wires is provided with a connection portion to which a wire of the electrical component to which a function is to be added is to be connected. With this configuration, it is possible to easily realize function-adding wire connection by connecting a wire to the connection portion provided in the electrical wire.

[5] The connection portion is a cutaway portion in which at least a portion of a core material of the electrical wire corresponding thereto is exposed. With this configuration, when a portion to which a wire is additionally connected is formed at an end portion of the electrical wire, it is only necessary to cut away the end portion of the electrical wire.

[6] The connection portion is provided with a waterproof portion that waterproofs the core material of the electrical wire. With this configuration, it is possible to protect the connection portion of the electrical wire from corrosion, using the waterproof portion, so that the connection portion can be made less likely to deteriorate.

[7] The plurality of electrical wires are arranged so as to be flat in a planar direction. With this configuration, the function-adding electrical wiring can be downsized in the thickness direction thereof.

[8] The attachment part is provided with an electrical wire fixing portion configured to fix the electrical wires to the attachment part. With this configuration, it is possible to fix the electrical wire, using the electrical wire fixing portion, in such a manner that the electrical wire is less likely to become detached from the attachment part.

[9] The electrical wire fixing portion includes: a binding member configured to bind the plurality of electrical wires together; and a binding member fixing rib configured to fix the binding member to a lid member provided for the attachment part. With this configuration, the binding member with the bunch of electrical wires can be firmly fixed to the lid member using the binding member fixing rib. Therefore, it is possible to make the electrical wires less likely to become detached from the lid member.

[10] The electrical wire fixing portion is constituted by a plurality of electrical wire fixing ribs with which the plurality of electrical wires are fitted into and fixed to a lid member provided for the attachment part. With this configuration, when the electrical wires are fixed by the electrical wire fixing portion, it is possible to secure large surface areas of the electrical wires exposed to the outside air, which contributes to a high heat radiation effect of the electrical wires. In addition, the configuration of each electrical wire fixing portion can be a simple structure having a simple rib shape.

[11] The electrical wires include a busbar wire formed on a lid member provided for the attachment part, and a retrofitted electrical wire configured to be retrofitted to the lid member, and the busbar wire and the retrofitted electrical wire are electrically connected via a connector provided for the lid member. With this configuration, the electrical wires and the attachment part can be configured as a unit component in which the busbar wire is integrated.

[12] A wire harness according to the present disclosure includes: a main harness; a protector through which the main harness is passed so as to regulate a wiring route for the main harness or partition a route for the main harness; and function-adding electrical wiring configured to be used when a function is to be added, wherein the function-adding electrical wiring includes: one or more electrical wires that are not initially used, and are to be electrically connected to an electrical component when a function is to be added; and an attachment part to which the electrical wires are attached, and that is attached and fixed to a protector body in which the main harness is routed. With the configuration according to the present disclosure, it is possible to achieve the same operations and effects as the function-adding electrical wiring.

### Details of Embodiments of Present Disclosure

Specific examples of function-adding electrical wiring and a wire harness according to the present disclosure will be described below with reference to the drawings. Note that the present invention is not limited to these examples, but is indicated by the scope of the claims, and is intended to include all modifications within the scope and meaning equivalent to the scope of the claims. In each figure, some of the components may be exaggerated or simplified for ease of explanation. Also, the dimensional ratio of each part may differ from the actual ratio.

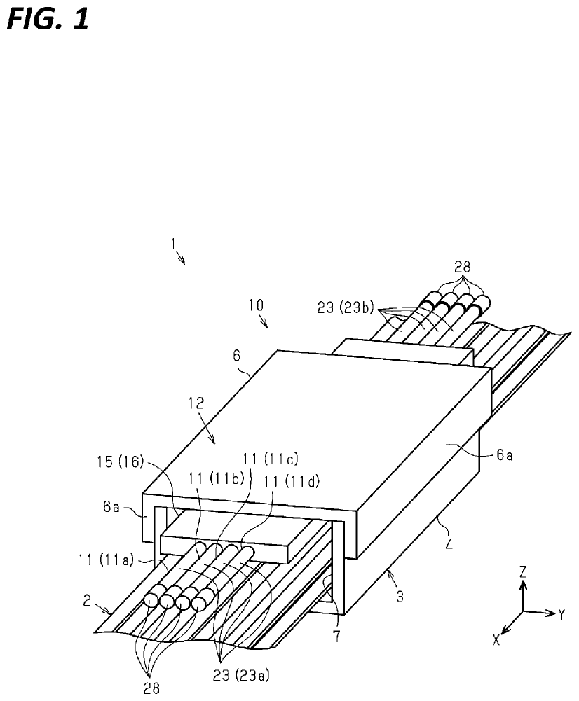

As shown in FIG. 1, a wire harness 1 is attached to the body of a vehicle as a harness for electrically connecting electrical components (not shown) of the vehicle. The wire harness 1 includes a main harness 2 that is used when the wire harness 1 is mounted in the vehicle, and a protector 3 that regulates a wiring route for the main harness 2 or partitions a detour route for the main harness 2. The main harness 2 may be constituted by one wire or a plurality of wires, for example.

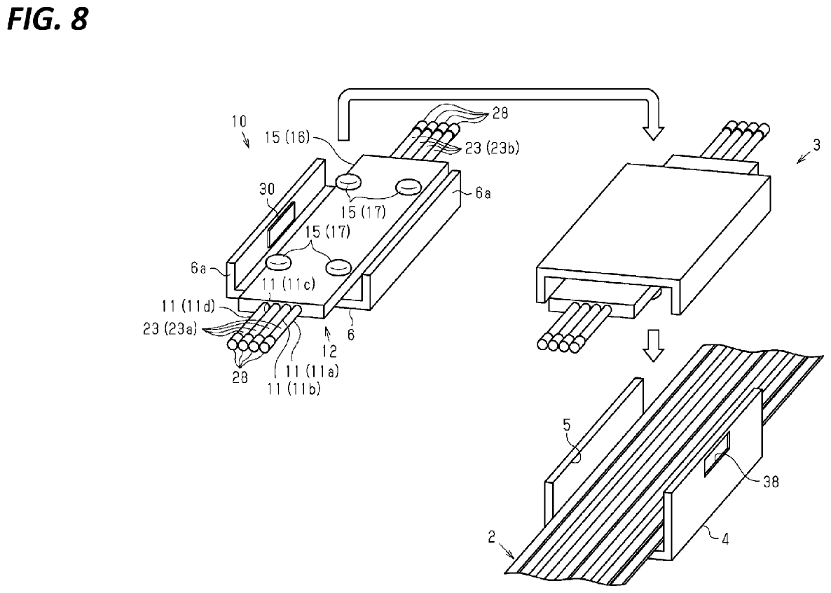

The protector 3 includes a protector body 4 through which the main harness 2 is routed, and a lid member 6 that closes an opening 5 (see FIG. 8) of the protector body 4. The protector 3 regulates the wiring route for the main harness 2 or defines the detour route for the main harness 2 when the passage for the electrical wire is restricted by existing components of the vehicle, for example. The protector body 4 is formed in a shape in which both ends in the longitudinal direction (the X axis direction in FIG. 1) of the protector 3 and an upper portion are open. The main harness 2 is passed through an insertion hole 7 opened in the longitudinal direction of the protector 3. The lid member 6 has a substantially square U-shaped cross section and closes the opening 5 of the upper portion of the protector body 4.

The wire harness 1 includes function-adding electrical wiring 10 that is used when a function is to be added. The function-adding electrical wiring 10 includes one or more electrical wires 11 and an attachment part 12. The electrical wires 11 are not initially used, and are to be electrically connected to an electrical component when a function is to be added. In the present example, a plurality of electrical wires 11 are provided and arranged side by side in the plane direction (the X-Y plane direction in FIG. 1). Thus, the electrical wires 11 are arranged so as to be flat. In the present example, the electrical wires 11 include a first electrical wire 11a, a second electrical wire 11b, a third electrical wire 11c, and a fourth electrical wire 11d.

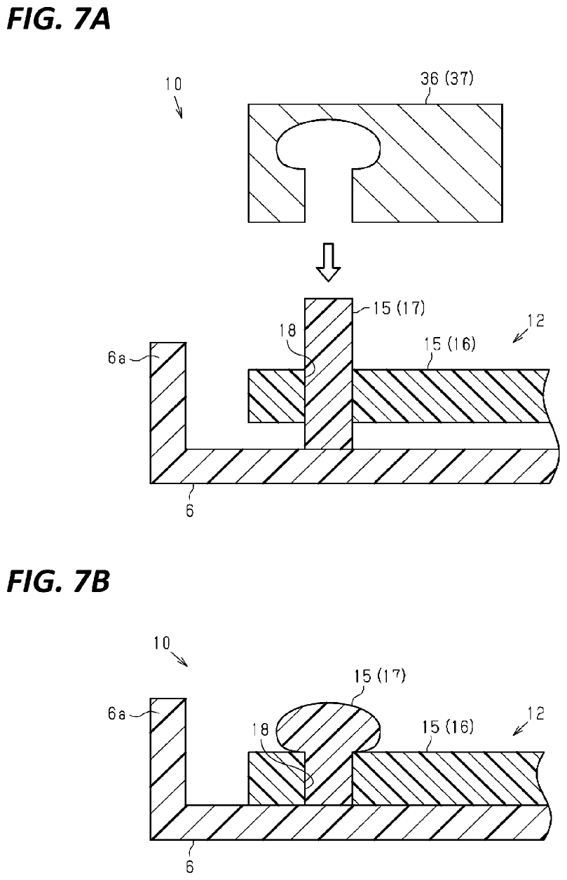

The attachment part 12 binds the plurality of electrical wires 11 together and is attached and fixed to the protector body 4 in which the main harness 2 is routed. In the present example, the attachment part 12 is provided with the above-described lid member 6 that closes the opening 5 (see FIGS. 7A and 7B) of the protector body 4. The lid member 6 closes the opening 5 of the protector body 4 so that the main harness 2 and the plurality of electrical wires 11 are positioned within the protector body 4.

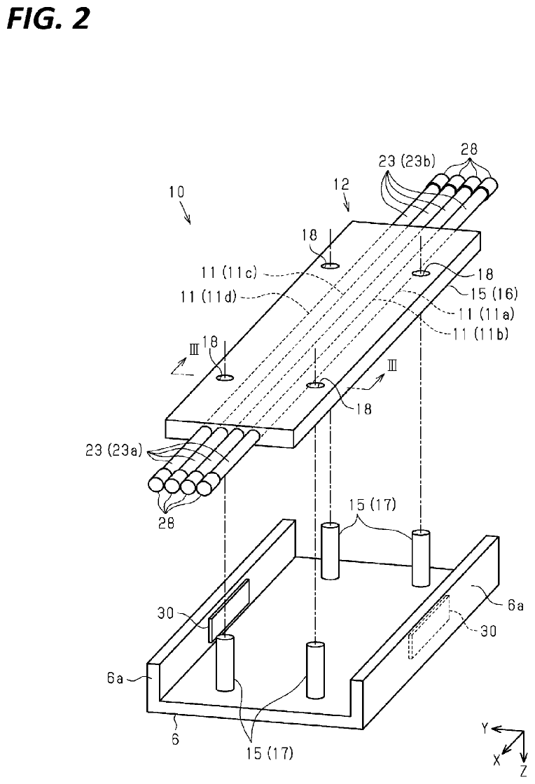

As shown in FIG. 2, the attachment part 12 is provided with electrical wire fixing portions 15 that fix the plurality of electrical wires 11 to the attachment part 12. The electrical wire fixing portions 15 include a binding member 16 that binds the plurality of electrical wires 11 together, and binding member fixing ribs 17 that fix the binding member 16 to the lid member 6 provided for the attachment part 12. A piece of non-woven fabric or tape is used as the binding member 16, for example. The binding member 16 is formed in a flat shape so as to match shape of the plurality of electrical wires 11 arranged side by side in the planar direction. It is preferable that the binding member fixing ribs 17 are, for example, protrusions provided on the rear surface of the lid member 6 so as to protrude therefrom. In the present example, four binding member fixing ribs 17 are provided at the four corners of the rear surface of the lid member 6.

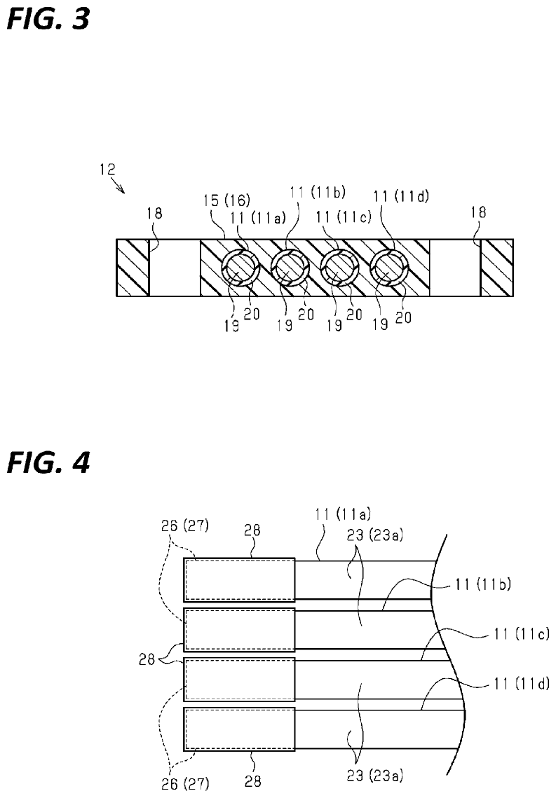

As shown in FIGS. 2 and 3, the binding member 16 is provided with a plurality of holes 18 to which the binding member fixing ribs 17 are attached. A total of four holes 18 are provided so as to be paired with the binding member fixing ribs 17, respectively. The binding member 16 is fixed to the lid member 6 by the binding member fixing ribs 17 inserted into the holes 18 and engage with them. It is preferable that each of the electrical wires 11 is a coated wire in which the circumference of a core material 19 is coated with an insulating coating material 20.

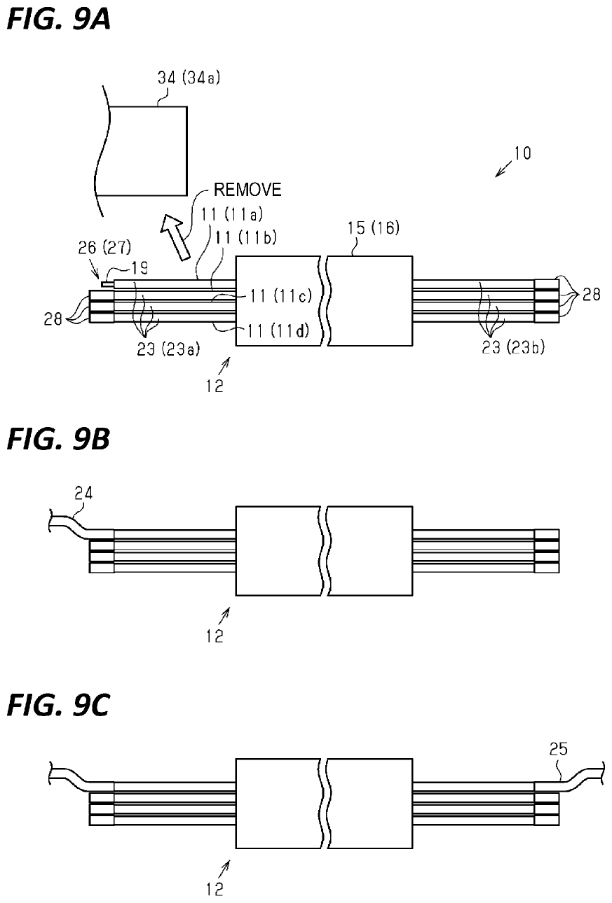

As shown in FIG. 2, each of the electrical wires 11 includes a pair of processed portions 23 that are exposed from the attachment part 12. In the present example, one of the processed portions 23 is referred to as a first processed portion 23a, and the other of the processed portions 23 is referred to as a second processed portion 23b. When a function is to be added, wires (additional wires 24 and 25, see FIGS. 9A to 9C, etc.) extending from an electrical component is electrically connected to the first processed portion 23a and the second processed portion 23b of an electrical wire 11.

The inner surface of the lid member 6 is provided with protruding pieces 30, at which the lid member 6 is fixed to the protector body 4. In the present example, a total of two protruding pieces 30 are respectively provided on the inner surfaces of a pair of side walls 6a of the lid member 6.

As shown in FIG. 4, at least one end portion of each electrical wire 11 is provided with a connection portion 26 to which the wires (additional wires 24 and 25, see FIGS. 9A to 9C, etc.) of the electrical component to which a function is to be added is to be connected. In the present example, connection portions 26 are provided at the respective end portions of the processed portions 23. Each connection portion 26 is, for example, a cutaway portion 27 in which at least a portion of the core material 19 (see FIG. 3, etc.) of the electrical wire 11 is exposed. Each connection portion 26 is provided with a waterproof portion 28 for waterproofing the core material 19 of the electrical wire 11. Examples of the waterproof portion 28 include a member such as cap or a tube.

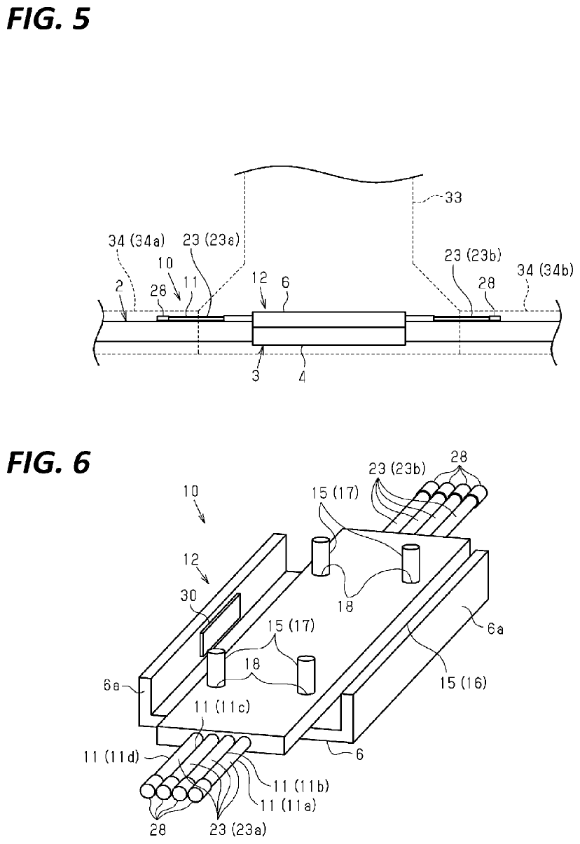

As shown in FIG. 5, the function-adding electrical wiring 10 is positioned below a pillar 33 provided in the vehicle. It is preferable that the pillar 33 is a B-pillar provided at the central position in the front-rear direction of the body of the vehicle, for example. The function-adding electrical wiring 10 is positioned so that the first processed portion 23a and the second processed portion 23b are exposed from the pillar 33. Scuff plates 34 configured to be removable from the body of the vehicle allow the first processed portion 23a and the second processed portion 23b of the function-adding electrical wiring 10 to be exposed to the outside. In the present example, the first processed portion 23a is hidden by a first scuff plate 34a, and a second processed portion 23b is hidden by a second scuff plate 34b.

Next, the operation of the function-adding electrical wiring 10 (the wire harness 1) according to the present embodiment will be described.

As shown in FIG. 6, first, the bunch of electrical wires 11 is attached and fixed to the attachment part 12. In the present example, the binding member 16 that binds the plurality of electrical wires 11 is prepared. Thereafter, the binding member fixing ribs 17 provided on the rear surface of the lid member 6 are respectively inserted into the holes 18 provided in the binding member 16, and thus the binding member 16 that binds the electrical wires 11 is attached to the rear surface of the lid member 6.

As shown in FIGS. 7A and 7B, the binding member 16 is firmly fixed to the binding member fixing ribs 17 by processing the binding member fixing ribs 17 inserted into the holes 18 of the binding member 16, using a jig 36. In the present example, a mold 37, which serves as the jig 36, is set to the leading end of each binding member fixing rib 17, and the leading end of the binding member fixing rib 17 is thermally melted using the mold 37 and deformed to have a larger diameter, thereby preventing the binding member 16 from coming off from the binding member fixing rib 17. Such processing is performed on all the binding member fixing ribs 17.

As shown in FIG. 8, after the binding member 16 including the bunch of electrical wires 11 is fixed to the lid member 6, the attachment part 12, in which the lid member 6 and the binding member 16 are integrated, is turned upside down, and the attachment part 12 is attached to the protector body 4. In the present example, the protruding pieces 30 provided on the lid member 6 engage with engagement target portions 38 (only one of them is shown in the figure) of the protector body 4, and thus the attachment part 12 is fixed to the protector body 4. According to the procedures described above, the attachment part 12 having the bunch of electrical wires 11 is fixed to the protector body 4, i.e., to the body of the vehicle.

As shown in FIG. 9A, when electrical components that were not attached to the vehicle at the time of factory manufacture are to be retrofitted, first, a scuff plate 34 (for example, in the case of retrofitting from the front side first, the first scuff plate 34a) is removed. Next, from among the plurality of electrical wires 11 prepared in the function-adding electrical wiring 10, the waterproof portion 28 of the first electrical wire 11a used for an electrical component to be retrofitted is removed. In the present example, the waterproof portion 28 attached to the first processed portion 23a of the first electrical wire 11a is removed. It is preferable that the waterproof portion 28 is removed from the first electrical wire 11a by, for example, cutting.

When the waterproof portion 28 is removed from the first electrical wire 11a, the connection portion 26 (cutaway portion 27) of the first processed portion 23a is exposed to the outside. Thereafter, the core material 19 of the first electrical wire 11a in the first processed portion 23a is exposed to the outside by, for example, cutting the coating material 20 of the exposed connection portion 26 (cutaway portion 27).

As shown in FIG. 9B, the additional wire 24 extending from the electrical component to be retrofitted is connected to the exposed core material 19. The additional wire 24 is fixed to the core material 19 of the first electrical wire 11a, using a crafting method such as soldering, for example.

As shown in FIG. 9C, in the first electrical wire 11a to which the additional wire 24 is connected, the additional wire 25 is also connected to the second processed portion 23b on the opposite side. Specifically, the second scuff plate 34b is removed and the waterproof portion 28 of the second processed portion 23b is removed, for example, so that the core material 19 is exposed. Thereafter, the additional wire 25 is connected to the exposed core material 19, and both ends of the first electrical wire 11a are made conductive. Thus, the retrofitted electrical component is attached to the body of the vehicle.

With the function-adding electrical wiring 10 (the wire harness 1) according to the above-described embodiment, it is possible to achieve the following effects.

(1-1) The function-adding electrical wiring 10 includes one or more electrical wires 11 and the attachment part 12. The electrical wires 11 are not initially used, and are electrically connected to electrical components when a function is to be added. The electrical wires 11 are attached to the attachment part 12, and the attachment part 12 is to be attached and fixed to the protector body 4 in which the main harness 2 is routed.

In the configuration according to the present example, the function-adding electrical wiring 10 has been prepared in the protector 3 as electrical wires to be used when a function is to be added. Therefore, when an electrical component is to be electrically connected when a function is to be added, it is possible to electrically connect the electrical component to be retrofitted by performing a simple operation, using an electrical wire 11 included in the function-adding electrical wiring 10. Therefore, it is possible to realize function addition without a drastic design change.

(1-2) In the case of a structure in which a plurality of electrical wires 11 are bound by the binding member 16, the arrangement of the electrical wires 11 can be determined in advance at the time of assembly. In addition, the plurality of electrical wires 11 can be arranged so as to be flat, and therefore variations in the arrangement of the electrical wires 11 can be suppressed. Furthermore, the number of assembly steps can be reduced.

(1-3) The attachment part 12 is provided with a lid member 6 that closes an opening 5 of the protector body 4. With this configuration, the attachment part 12 can also be used as the lid member 6 for the protector 3, which contributes to reducing the number of parts.

(1-4) The lid member 6 closes the opening 5 of the protector body 4 so that both the main harness 2 and the electrical wires 11 are positioned within the protector body 4. With this configuration, the electrical wire group constituted by the main harness 2 and the function-adding electrical wires 11 can be housed within the protector 3, so that the electrical wire group does not have to be left exposed to the outside.

(1-5) At least one end portion of each electrical wire 11 is provided with a connection portion 26 for connecting thereto a wire of an electrical component, to which a function is to be added. With this configuration, it is possible to easily realize function-adding wire connection by connecting a wire to the connection portion 26 provided in the electrical wire 11.

(1-6) The connection portion 26 is a cutaway portion 27 from which at least a portion of the core material 19 of the electrical wire 11 is exposed. With this configuration, when a portion to which a wire is additionally connected is formed at an end portion of the electrical wire 11, it is only necessary to cut away the end portion of the electrical wire 11.

(1-7) The connection portion 26 is provided with a waterproof portion 28 that waterproofs the core material 19 of the electrical wire 11. With this configuration, it is possible to protect the connection portion 26 of the electrical wire 11 from corrosion, using the waterproof portion 28, so that the connection portion 26 can be made less likely to deteriorate.

(1-8) The plurality of electrical wires 11 are arranged so as to be flat in a planar direction. With this configuration, the function-adding electrical wiring 10 can be downsized in the thickness direction thereof.

(1-9) The attachment part 12 is provided with electrical wire fixing portions 15 that fix the electrical wire 11 to the attachment part 12. With this configuration, it is possible to fix the electrical wire 11, using the electrical wire fixing portions 15, in such a manner that the electrical wire 11 is less likely to become detached from the attachment part 12.

(1-10) The electrical wire fixing portions 15 include a binding member 16 that binds the plurality of electrical wires 11, and binding member fixing ribs 17 that fix the binding member 16 to the lid member 6 provided for the attachment part 12. With this configuration, the binding member 16 with the bunch of electrical wires 11 can be firmly fixed to the lid member 6 using the binding member fixing ribs 17. Therefore, it is possible to make the electrical wires 11 less likely to become detached from the lid member 6.

### Second Embodiment

Next, a second embodiment will be described. Note that, in the configuration according to the second embodiment, the attachment structure for the electrical wires 11 according to the first embodiment is modified. Therefore, the same reference numerals will be given to the same parts as in the first embodiment and the description thereof will be omitted, and only the different parts will be described in detail.

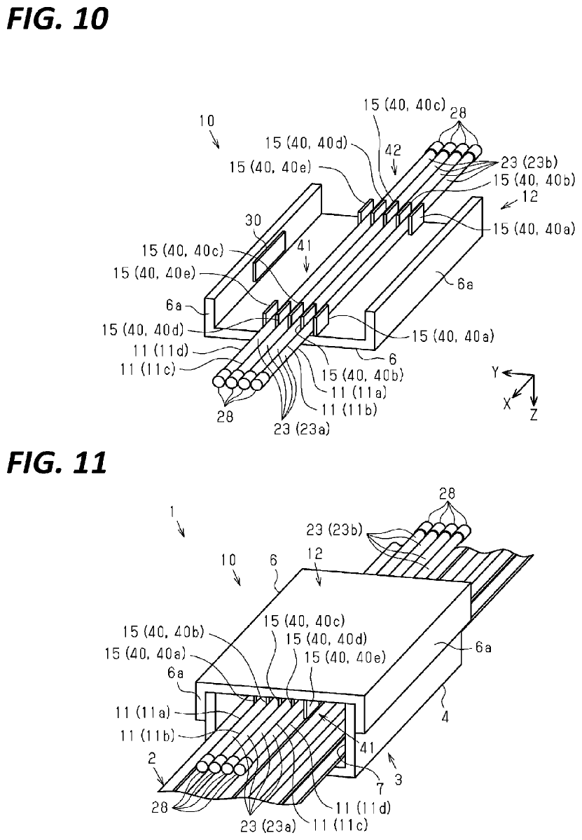

As shown in FIG. 10, the electrical wire fixing portions 15 are constituted by a plurality of electrical wire fixing ribs 40 with which the electrical wires 11 are fitted into and fixed to the lid member 6 provided for the attachment part 12. The plurality of electrical wire fixing ribs 40 are provided at both end portions of the lid member 6 in the longitudinal direction thereof as rib groups (a first rib group 41 and a second rib group 42). The ribs included in the first rib group 41 and the second rib group 42 are arranged in the width direction of the lid member 6 (the Y axis direction in FIG. 10) at intervals corresponding to the diameter of each electrical wire 11.

As shown in FIGS. 10 and 11, in the present example, the first electrical wire 11a is attached and fixed between a first electrical wire fixing rib 40a and a second electrical wire fixing rib 40b. It is preferable that the first electrical wire 11a is press-fitted and fixed between the first electrical wire fixing rib 40a and the second electrical wire fixing rib 40b. Similarly, the second electrical wire 11b is attached and fixed between the second electrical wire fixing rib 40b and a third electrical wire fixing rib 40c, the third electrical wire 11c is attached and fixed between a third electrical wire fixing rib 40c and a fourth electrical wire fixing rib 40d, and the fourth electrical wire lid is attached and fixed between a fourth electrical wire fixing rib 40d and a fifth electrical wire fixing rib 40e.

With the function-adding electrical wiring 10 (the wire harness 1) according to the above-described embodiment, it is possible to achieve the following effects in addition to the effects described in the first embodiment.

(2-1) The electrical wire fixing portions 15 are constituted by a plurality of electrical wire fixing ribs 40 with which the electrical wires 11 are fitted into and fixed to the lid member 6 provided for the attachment part 12. With this configuration, when the electrical wires 11 are fixed by the electrical wire fixing portions 15, it is possible to secure large surface areas of the electrical wires 11 exposed to the outside air, which contributes to a high heat radiation effect of the electrical wires 11. In addition, the configuration of each electrical wire fixing portion 15 can be a simple structure having a simple rib shape.

### Third Embodiment

Next, a third embodiment will be described. Note that the third embodiment will also be described in detail only with regard to portions that differ from those of the first and second embodiments.

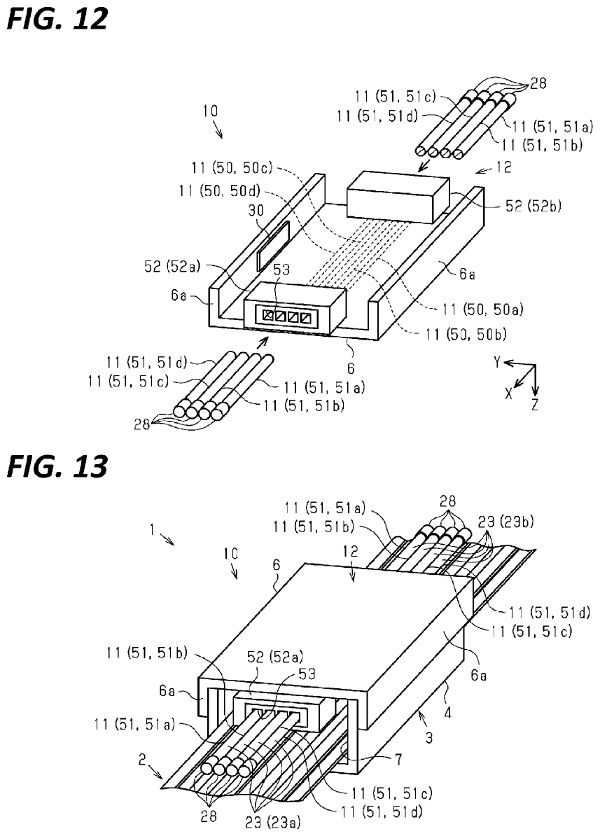

As shown in FIG. 12, the electrical wires 11 include busbar wires 50 formed on the lid member 6 provided for the attachment part 12, and retrofitted electrical wires 51 that are retrofitted to the lid member 6. The busbar wires 50 are formed on the lid member 6 by resin molding. In the present example, there are four busbar wires 50, namely a first busbar wire 50a, a second busbar wire 50b, a third busbar wire 50c, and a fourth busbar wire 50d.

The retrofitted electrical wires 51 are each provided so as to be paired with one of the busbar wires 50. In the present example, the retrofitted electrical wires 51 include a pair of first retrofitted electrical wires 51a respectively connected to the end portions of the first busbar wires 50a, a pair of second retrofitted electrical wires 51b respectively connected to the end portions of the second busbar wires 50b, a pair of third retrofitted electrical wires 51c respectively connected to the end portions of the third busbar wires 50c, and a pair of fourth retrofitted electrical wires 51d respectively connected to the end portions of the fourth busbar wires 50d.

The busbar wires 50 and the retrofitted electrical wires 51 are electrically connected via connectors 52 provided for the lid member 6 of the attachment part 12. In the present example, the connectors 52 include a first connector 52a provided at one end in the longitudinal direction (the X axis direction in FIG. 12) of the lid member 6 and a second connector 52b provided at the other end in the longitudinal direction of the lid member 6. It is preferable that the first connector 52a and the second connector 52b are formed integrally with the lid member 6.

As shown in FIG. 13, one of the pair of first retrofitted electrical wires 51a is connected to a terminal 53 of the first connector 52a, and the other is connected to a terminal (not shown) of the second connector 52b. Similarly, the second retrofitted electrical wires 51b, the third retrofitted electrical wires 51c, and the fourth retrofitted electrical wires 51d are connected to the first connector 52a and the second connector 52b. The retrofitted electrical wires 51 may be attached to the connectors 52 using a known snap-fit structure, or using processing such as soldering, for example.

With the function-adding electrical wiring 10 (the wire harness 1) according to the above-described embodiment, it is possible to achieve the following effects in addition to the effects described in the first embodiment.

(3-1) The electrical wires 11 include busbar wires 50 formed on the lid member 6 provided for the attachment part 12, and retrofitted electrical wires 51 that are retrofitted to the lid member 6. The busbar wires 50 and the retrofitted electrical wires 51 are electrically connected via connectors 52 provided for the lid member 6. With this configuration, the electrical wires 11 and the attachment part 12 can be configured as a unit component in which the busbar wires 50 are integrated.

The present embodiment may be modified and implemented as follows. The present embodiment and the following modifications may be implemented in combination with each other as long as no technical contradiction arises.
In each embodiment, the plurality of electrical wires 11 are not limited to being arranged so as to be flat, and a certain number of wires may be stacked in the thickness direction.
In each embodiment, when a plurality of electrical wires 11 are provided, the types (diameters, etc.) thereof may be different from each other.
In each embodiment, the two end portions of each electrical wire 11 may have different shapes. For example, one end portion of an electrical wire 11 may have a cutaway shape and the other end portion may have a connector.
In each embodiment, there may be a plurality of electrical wires 11 or only one electrical wire 11.
In each embodiment, the connection portion 26 is not limited to being a cutaway portion 27, and may be a connector to which the additional wires 24 and 25 can be connected, for example.
In each embodiment, the waterproof portion 28 is not limited to being a cap, and may be a portion formed by winding a piece of tape, for example.
In each embodiment, the attachment part 12 is not limited to being a lid member 6 for the protector body 4. For example, instead of being a lid for the protector body 4, the attachment part 12 may be a member that is simply attached to the protector body 4.
In each embodiment, even if the attachment part 12 is used as a lid for the protector body 4, it is possible to employ a configuration in which the electrical wires 11 are not arranged inside the protector 3, for example.
In each embodiment, the protector body 4 may be a member provided integrally with the body of the vehicle.
In the first embodiment, the method for processing the binding member fixing ribs 17 is not limited to the method for thermally melting the leading ends using the mold 37. For example, other methods such as crushing the leading ends with an instrument may be adopted.
In the first embodiment, the binding member 16 is not limited to having a flat shape, and the shape thereof may be changed to another shape such as a columnar shape.
In the first embodiment, a rib shape may be provided on the binding member 16, and a recess allowing the rib to pass therethrough may be provided in the lid member 6.
In the first embodiment, the electrical wire fixing portions 15 need only have a structure that can fix the binding member 16 to the lid member 6.
In the second embodiment, the electrical wire fixing ribs 40 may each be provided with a protrusion such as a claw to prevent the attached electrical wires 11 from becoming detached.
In each embodiment, the shape of the lid member 6 may be changed to a shape other than that in the embodiment.
In each embodiment, the method for engaging the protector body 4 and the lid member 6 with each other may be changed to various methods as long as the lid member 6 can be fixed to the protector body 4.
In each embodiment, the position at which the function-adding electrical wiring 10 is attached is not limited to the position near the pillar 33, and may be changed to another position such as the lower surface of the floor of the driver's seat.
In each embodiment, the function-adding electrical wiring 10 may be used for devices or systems other than the vehicle.
In each embodiment, the main harness 2 may be routed in the protector body 4 in a state of being electrically connected to an electrical component, and the attachment part 12 may be attached to the protector body 4 in a state of fixing and holding the electrical wires 11 that are not connected to the electrical component.
As shown in FIGS. 1, 5, 11, and 13, both end portions of each electrical wire 11 of the function-adding electrical wiring 10 may be in contact with the outer surface of the main harness 2 in the radial direction thereof, or face thereto with a gap. Each electrical wire 11 of the function-adding electrical wiring 10 may be terminated in the vicinity of the two ends of the attachment part 12, or the protector 3, or the lid member 6.
The main harness 2 according to the illustrated embodiments may include: a first intermediate length portion covered by the attachment part 12, the protector 3, or the lid member 6; a first length portion that may have a first extension length, that extends from the first intermediate length portion toward a first end or a leading end of the main harness 2 and that is not covered by the attachment part 12, the protector 3, or the lid member 6; and a second length portion that may have a second extension length, that extends from the first intermediate length portion toward a second end or a base end of the main harness 2, and that is not covered by the attachment part 12, the protector 3, or the lid member 6. The function-adding electrical wiring 10 may include: a second intermediate length portion covered by the attachment part 12, the protector 3, or the lid member 6; a third length portion that may have a third extension length, that extends from the second intermediate length portion toward a first end or a leading end of the function-adding electrical wiring 10 and that is not covered by the attachment part 12, the protector 3, or the lid member 6; and a fourth length portion that may have a fourth extension length, that extends from the second intermediate length portion toward a second end or a base end of the function-adding electrical wiring 10, and that is not covered by the attachment part 12, the protector 3, or the lid member 6.

The first intermediate length portion of the main harness 2 may have a first intermediate length that is the same as the length of the attachment part 12, the protector 3, or the lid member 6. The second intermediate length portion of the function-adding electrical wiring 10 may have the same length as the attachment part 12, the protector 3, or the lid member 6, or the same length as the first intermediate length portion of the main harness 2. In the illustrated embodiments, the third extension length of the third length portion of the function-adding electrical wiring 10 is shorter than the first extension length of the first length portion of the main harness 2, and the fourth extension length of the fourth length portion of the function-adding electrical wiring 10 is shorter than the second extension length of the second length portion of the main harness 2.
In each embodiment, the present disclosure has been described with reference to examples, but it should be understood that the present disclosure is not limited to the examples or the structures. The present disclosure also encompasses various modifications and variations within an equivalent range. In addition, various combinations and forms, and other combinations and forms including only one element, more or less, are also included in the scope and spirit of the present disclosure.

### LIST OF REFERENCE NUMERALS

1 Wire Harness
2 Main Harness
3 Protector
4 Protector Body
5 Opening
6 Lid Member
6a Side Wall
10 Function-Adding Electrical Wiring
11 Electrical Wires
11a First Electrical Wire
11b Second Electrical Wire
11c Third Electrical Wire
12 lid Fourth Electrical Wire
12 Attachment Part
15 Electrical Wire Fixing Portion
16 Binding Member
17 Binding Member Fixing Rib
18 Hole
19 Core Material
20 Coating Material
23 Processed Portions
23a First Processed Portion
23b Second Processed Portion
24 Additional Wire
25 Additional Wire
26 Connection Portion
27 Cutaway Portion
28 Waterproof Portion
30 Protruding Piece
33 Pillar
34 Scuff Plates
34a First Scuff Plate
34b Second Scuff Plate
36 Jig
37 Mold
38 Engagement Target Portion
40 Electrical Wire Fixing Ribs
40a First Electrical Wire Fixing Rib
40b Second Electrical Wire Fixing Rib
40c Third Electrical Wire Fixing Rib
40d Fourth Electrical Wire Fixing Rib
40e Fifth Electrical Wire Fixing Rib
41 First Rib Group
42 Second Rib Group
50 Busbar Wires
50a First Busbar Wire
50b Second Busbar Wire
50c Third Busbar Wire
50d Fourth Busbar Wire
51 Retrofitted Electrical Wires
51a First Retrofitted Electrical Wire
51b Second Retrofitted Electrical Wire
51c Third Retrofitted Electrical Wire
51d Fourth Retrofitted Electrical Wire
52 Connectors
52a First Connector
52b Second Connector
53 Terminal

1. Function-adding electrical wiring comprising:
one or more electrical wires that are not initially used, and are to be electrically connected to an electrical component when a function is to be added; and
an attachment part to which the electrical wires are attached, and that is to be attached and fixed to a protector body in which a main harness is routed.

2. The function-adding electrical wiring according to claim 1,
wherein the attachment part is provided with a lid member configured to close an opening of the protector body.

3. The function-adding electrical wiring according to claim 2,
wherein the lid member is configured to close the opening of the protector body so that both the main harness and the electrical wires are positioned within the protector body.

4. The function-adding electrical wiring according to claim 1,
wherein at least one end portion of each of the electrical wires is provided with a connection portion to which a wire of the electrical component to which a function is to be added is to be connected.

5. The function-adding electrical wiring according to claim 4,
wherein the connection portion is a cutaway portion in which at least a portion of a core material of the electrical wire corresponding thereto is exposed.

6. The function-adding electrical wiring according to claim 5,
wherein the connection portion is provided with a waterproof portion that waterproofs the core material of the electrical wire.

7. The function-adding electrical wiring according to claim 1,
wherein the plurality of electrical wires are arranged so as to be flat in a planar direction.

8. The function-adding electrical wiring according to claim 1,
wherein the attachment part is provided with an electrical wire fixing portion configured to fix the electrical wires to the attachment part.

9. The function-adding electrical wiring according to claim 8,
wherein the electrical wire fixing portion includes:
a binding member configured to bind the plurality of electrical wires together; and
a binding member fixing rib configured to fix the binding member to a lid member provided for the attachment part.

10. The function-adding electrical wiring according to claim 8,
wherein the electrical wire fixing portion is constituted by a plurality of electrical wire fixing ribs with which the plurality of electrical wires are fitted into and fixed to a lid member provided for the attachment part.

11. The function-adding electrical wiring according to claim 1,
wherein the electrical wires include a busbar wire formed on a lid member provided for the attachment part, and a retrofitted electrical wire configured to be retrofitted to the lid member, and
the busbar wire and the retrofitted electrical wire are electrically connected via a connector provided for the lid member.

12. A wire harness comprising:
a main harness;
a protector through which the main harness is passed so as to regulate a wiring route for the main harness or partition a route for the main harness; and
function-adding electrical wiring configured to be used when a function is to be added,
wherein the function-adding electrical wiring includes:
one or more electrical wires that are not initially used, and are to be electrically connected to an electrical component when a function is to be added; and
an attachment part to which the electrical wires are attached, and that is attached and fixed to a protector body in which the main harness is routed.
